(19) United States
(12) Patent Application Publication
(10) Pub. No.: US 2013/0110907 A1
(43) Pub. Date: May 2, 2013

(54) METHOD AND SYSTEM FOR MERGING, CORRECTING, AND VALIDATING DATA

(71) Applicants: REUVEN J. SHERWIN, RA'ANANA (IL); JEAN-PIERRE VAN DE CAPELLE, WEBSTER, NY (US); JI FANG, MOUNTAIN VIEW, CA (US)

(72) Inventors: REUVEN J. SHERWIN, RA'ANANA (IL); JEAN-PIERRE VAN DE CAPELLE, WEBSTER, NY (US); JI FANG, MOUNTAIN VIEW, CA (US)

(73) Assignee: Xerox Corporation, Norwalk, CT (US)

(21) Appl. No.: 13/287,579

(22) Filed: Nov. 2, 2011

(51) Int. Cl. G06F 15/16

(52) U.S. Cl. 709/203

(57) ABSTRACT

A system and method for augmenting contact information is provided. The system can be configured to receive at least two contact information data sets. The system is further configured to analyze the two contact information data sets and produces a ‘union’ of information between the two data sets for augmenting one of the data sets with the other data set using unique or non-duplicative data fields.

### BACKGROUND

An electronic address book, contact information or list, or database can include fields of data entries that store telephone numbers, email addresses, physical addresses, etc. for a user or contact and in-turn his/her associated contacts. An electronic profile is a collection of a user's information that may be broader than the data entries provided in an address book. For example, besides the information contained in an address book, a profile may also include preference information (e.g., a user's favorite music or movies), financial information (e.g., bank and/or credit account information), a birth date, passport information, images, etc. In general, a profile can be considered private to one person and includes the information that the person wants to protect and store, while an address book can be considered public and includes information that can be shared with others (e.g., contacts, friends, family, etc.).

Address books, contact information or lists, and/or databases often contain wrong information about a person's identity, such as wrong spelling of the name, wrong name, wrong address, wrong age, wrong company affiliation, wrong gender, wrong phone number, etc. Causes of incorrect information can be human error, such as errors introduced during manual entry of information, or information can become outdated because of changes in a person's life. In addition, such errors can be introduced by existing address book tools, which often identify names incorrectly from an email address, or other data field, chosen to be added to the address book.

Address books, including contacts and associated contact information, can be owned and maintained by different people, different organizations or entities, and can reside on the same or different devices. The devices and information (e.g. the databases) can be owned or managed by, for example, an employee of a company with a direct relationship to the consumer. Alternatively, the information can be owned by a company which specializes in managing name lists, i.e. databases. In some cases, one central database (e.g. a database maintained by a name list service provider) will have more up to date information than a particular company's central database. In other cases, it may be the other way around. In still other cases, the devices and information can be owned and/or managed by individuals including self-management (i.e. social and professional networks) of the contact information and profile information contained therein.

### SUMMARY

A system for augmenting contact information is provided, comprising a first device configured to store a first contact and first contact information; and provide, to a server, the first contact and the first contact information. The system further comprises at least a second device configured to store a second contact and second contact information; and provide, to the server, the second contact information. The server is configured to receive the first contact and the first contact information from the first device, and receive the second contact and the second contact information from the at least second device. The server is configured to analyze the first contact information and the second contact information to determine a first likelihood that the second contact and the first contact are the same contact. The server is further configured to analyze the first contact information and the second contact information to determine a second likelihood that the second contact information augments the first contact information of the first contact. If the first and the second likelihoods are higher than pre-set thresholds, augment the first contact information with the second contact information using unique or non-duplicative data fields from the second contact information. The analyzing comprises at least one comparison selected from the group consisting of natural language processing, named entity (name, address etc.) recognition, field mapping, content comparison, source comparison, search-engine retrieved-data comparison, and image comparison.

A system for augmenting contact information is provided, comprising a first device configured to store a first contact and associated first contact information; and provide, to a server, the first contact and the first contact information. The system further provides at least a second device configured to store a second contact and associated second contact information; and provide, to the server, the second contact information. The server is configured to receive the first contact and the first contact information from the first device, and receive the second contact and the second contact information from the at least second device. The server is further configured to analyze the first contact information and the second contact information to determine a first likelihood that the second contact and the first contact are the same contact; and still the server is configured to analyze the first contact information and the second contact information to determine a second likelihood that the second contact information augments the first contact information of the first contact. If the first and the second likelihoods are higher than pre-set thresholds, augment the first contact information with the second contact information using unique [JP1] data fields from the second contact information. Each of the data fields can be tagged in the first contact information and the second contact information with identifiers about respective origin; and, wherein the augmenting results in at least one of the unique data fields being added or amended to the first contact information.

A method for augmenting contact information is provided, comprising storing in a first device a first contact and associated first contact information; and, providing to a server the first contact and the first contact information. The system further comprises storing in at least a second device a second contact and associated second contact information; and, providing to the server the second contact and the second contact information. The server receives the first contact and the first contact information from the first device, and receives the second contact the second contact information from the at least second device. The server analyzes the first contact information and the second contact information to determine whether the first contact and the second contact are a common contact. The server is configured to analyze the first contact information and the second contact information to determine a first likelihood that the second contact and the first contact are the same contact. The server is further configured to analyze the first contact information and the second contact information to determine a second likelihood that the second contact information augments the first contact information of the first contact. If the first and the second likelihoods are higher than pre-set thresholds, augment the first contact information with the second contact information using unique [JP2] data fields from the second contact information. The augmenting results in at least one unique [JP3] data field being added or amended to the first contact information. The analyzing is further based on comparisons selected from the group consisting of field mapping, image comparison, named entity comparison, source comparison, search-engine retrieved-data comparison, and content comparison.

### BRIEF DESCRIPTION OF THE DRAWINGS

FIG. 1 depicts a diagram of an exemplary network in which systems and/or methods described herein may be implemented;

FIG. 2 illustrates exemplary components (i.e. data fields) of two contact databases for a common contact; and,

FIG. 3 illustrates another exemplary arrangement of data fields for two contact databases for a common contact.

### DETAILED DESCRIPTION

The following detailed description refers to the accompanying drawings. The same reference numbers in different drawings may identify the same or similar elements.

Systems and/or methods described herein may enable a user to manage or augment aspects of a first address book or first contact information (e.g., an electronic address book or database), with a second contact and/or at least a second contact information including profiles (e.g., electronic profiles) possibly associated to the first contact, from a variety of user devices (e.g., a cell phone, a personal digital assistant (PDA), a television, an Internet-based device, laptop or home-based computer, etc.). In one implementation, for example, the systems and/or methods may receive one or more contacts, including contact information associated with a user or other users, and may receive profile information associated with the same or common user or other users. The systems and/or methods may link the profile information with one or more corresponding contacts in the address book, and may augment the first address hook with the linked or associated profile information, another address book, or another contact information, to one or more user devices associated with the user (i.e. common user or common contact).

Some products allow a user to synchronize and backup an address book (e.g., associated with a user device) with a server. It is to be appreciated that a server can be any device capable of storing contact information and/or analyzing contact information. Furthermore, some products allow a user to create profiles and to link profiles between friends and family. To be described in more detail hereinafter, the present disclosure provides for a system that can synchronize, update, and/or detect inaccuracies in a user's informational data set(s) from a multitude of distinct user devices, contact information sources, address books and/or databases.

An “address book,” as the term is used herein, is to be broadly construed to include, for example, an electronic address book that includes a list of contacts, where each contact may have associated contact information including predefined data fields (e.g., identifier and value, such as, a home telephone number, a cell phone number, address information, etc.). An address book will typically include sharable public information. It is to be appreciated that the data fields can include the identifier or associated value, or both. The data fields can include identifier-value or attribute-value pairs, or can include the value field only portion. For example, the attribute can be the same, or refer to the same (example “address” and “street address”), wherein the value field can be different. Additionally, the attribute may not exist in the first contact information but may exist in the second contact information (e.g. first contact does not have “web page address” or does not have “2nd street address”, while the second contact does). Thus, augmenting unique or non-duplicative data may involve the ‘union’ of data sets between the first contact information and the second contact information.

A “profile,” as the term is used herein, can be broadly construed to include, for example, information that describes a user, such as, contact information, personal information, professional information, personal preferences, collections of favorite music, movies, or pictures, etc. Profile information will typically include private information or selectively sharable information.

A “connected address book,” a “networked address book,” or a “linked address book,” as the terms are used herein, are to be broadly construed to include, for example, a connected or augmented address book that includes contacts and contact information connected/linked to corresponding or identified same said contacts. The address book may be “connected” since address books on multiple user devices (e.g., a cell phone, a PDA, a laptop computer, etc.) associated with a user may be connected. For example, the address books on the multiple user devices may be connected such that a change in an address book on one of the user devices may be reflected in the address books on the other user devices. The address book may be augmented or “networked” since address book users may be networked through the address book and profile sharing and social networking. Furthermore, one user's address book may be networked among multiple user devices associated with the user. A permanent copy of the user's address book may be stored on a network device (e.g., a server) so that if the user changes a user device, the user may obtain the address book from the network device. As used herein, the terms “user” and “owner” are intended to be broadly interpreted to include a user device or a contact and/or owner of a user device.

A database of contact information can reside on a central server, or it (or a copy of it) can also reside on different mobile devices such as laptops, phones, PDAs, etc. In many cases it is convenient to have access to the database and be able to modify the database when access to the centrally maintained database is not available (e.g. no network connectivity). As such, two or more instances of a database can change independently of one another. In many cases, dates or time stamps are not accurate in one of the copies thus casting doubt as to which database change was the most recent update. In such situations, identifying the most accurate or most up-to-date database is subject to error.

Due to the reasons outlined above, it can become very difficult to know for any particular contact which list/database contains the correct information. False information is then often integrated into one or more databases and subsequently used in some manner. As an example, the information can be used to feed a marketing campaign, and the recipients of the campaign material are then very likely to be confronted with mistakes regarding their contact information. This can weaken the relationship between the recipient of the campaign material and the campaign owner, which ultimately is likely the exact opposite effect of the campaign's intention.

Today many people maintain separate address books and profiles of various business and social contacts. This can lead to multiple versions of what could be the same contact information, extra work to synchronize data, and often ultimately to data inaccuracies and obsolescence. Computerized contact lists are available and convenient, and are often present on readily available mobile electronics such as cell phones. However, current synchronization methods do a poor job of merging data (i.e. data fields) from multiple sources, often resulting in duplication of records, inaccurate information, misidentified information, or loss of information.

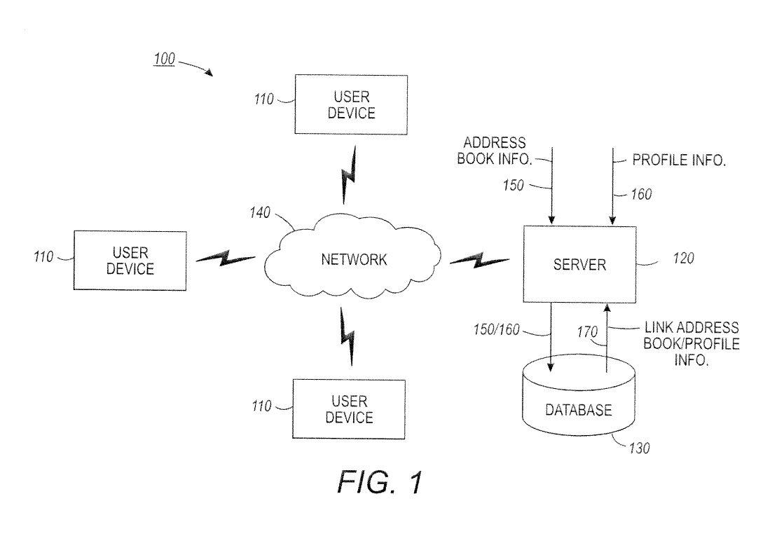

FIG. 1 is a diagram of an exemplary network 100 in which systems and/or methods described herein may be implemented. As illustrated, network 100 may include one or more user devices 110, a server 120, and a database 130 interconnected by a network 140. Components of network 100 may interconnect via wired and/or wireless connections. Three user devices 110, a single server 120, a single database 130, and a single network 140 have been illustrated in FIG. 1 for simplicity. In practice, there may be more or less user devices 110, and more servers 120, databases 130, and/or networks 140. Also, in some instances, one or more of the components of network 100 may perform one or more functions described as being perfoi wed by another one or more of the components of network 100.

Each of user devices 110 may include any device that is capable of accessing server 120 via network 140. For example, each of user devices 110 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a personal computer, a set-top box (STB), a television, a personal gaming system, or other types of computation or communication devices, threads or processes running on these devices, and/or objects executable by these devices. Each of user devices 110 may enable a user to change the user's profile, to perform a search for other user profiles, to link to other user profiles, to store a local address book, and/or to synchronize the local address book with a networked address book stored by server 120 (e.g., in database 130).

Server 120 may include one or more server entities, or other types of computation or communication devices, that gather, process, search, and/or provide information in a manner described herein. In one implementation, server 120 may securely (e.g., via user authentication) retrieve an address book or a profile for a user associated with one of user devices 110, may provide the profile to user device 110, may receive modifications and/or changes to the profile from user device 110, and may store the changes/modifications in database 130. In another implementation, server 120 may search a profile database (e.g., provided in database 130) based on a profile search request (e.g., that includes a user name, email address, location, telephone number, etc.) received from one of user devices 110, and may return profile search results with limited information based on the profile search request.

In still another implementation example, server 120 may receive, from one of user devices 110, a request to link an address book contact entry with a profile (e.g., that may be returned with the profile search results), and may provide the link request (e.g., via an email or a Short Message Service (SMS) text message) to one or more user devices 110 associated with the requested profile's user. If the requested profile's user accepts the link request, server 120 may link the profile with the contact of the address book associated with the user generating the link request.

In a further implementation, server 120 may store a server address book (e.g., in database 130) for each user associated with one or more user devices 110. If a profile (e.g., provided in the profile database) is changed or updated, server 120 may update all address book entries that include a link to the updated profile. Server 120 may synchronize the server address books with the local address books provided on corresponding user devices 110. If a local address book provided on one user device 110 is updated, server 120 may update a server address book associated with the local address book, and may synchronize the updated server address book with local address books provided on other user devices 110. For example, if a user, via a cell phone, updates the local address book provided on the cell phone, server 120 may update a server address book associated with the cell phone's local address book, and may synchronize the updated server address book with a local address book provided on a personal computer associated with the user. Such an arrangement may ensure that an address book associated with a user is updated and synchronized for each of the user devices 110 associated with the user, wherein the analyzing comprises at least one comparison using the following techniques: natural language processing, named entity (name, address etc.) recognition, field mapping, content comparison, source comparison, search-engine retrieved-data comparison, and image comparison. To be described in more detail hereinafter, source comparison, search-engine retrieved-data comparisons comprise not only the identification of data sources, but also the validating and/or ‘grading’ of said data sources. The grading of data sources is directed at a determination or likelihood that one data source is more accurate, up-to-date, and/or reliable than another data source.

In one exemplary implementation, as further shown in FIG. 1, server 120 may receive address book information 150 and profile information 160, and may provide address book information 150 and profile information 160 to database 130. Address book information 150 may include address books (and corresponding contact information) of one or more users associated with one or more user devices 110. Profile information 160 may include profiles of one or more users associated with one or more user devices 110. Server 120 (e.g., via coordination with database 130) may link profile information 160 with one or more corresponding contacts provided in one or more address books (e.g., provided via address book information 150), as shown by reference number 170. Server 120 may provide the address books with the linked profile information to one or more user devices 110 associated with the one or more users.

The aforementioned synchronization process may lead to inaccuracies of contact information, lack of synchronization altogether, and/or lack of identifying a common contact. The present disclosure provides a synchronization technology based on syntactic, semantic, and/or image data analysis that corrects mistakes and reduces redundancy and data-loss in contact sets (i.e. matching pairs or sets) merged from multiple sources. A company or person can update a particular ‘master’ database, using other distinct databases or other sources of information. Some of the sources of information or databases can be created dynamically through semantic analysis of publicly available data and profiles (e.g. Facebook, LinkedIn, phone company directories, public web sites, etc.). The technology can include a scalable and extendable system that read in address books and profiles, and iterates the contacts and data fields contained therein. The systems can implement algorithms for uniquely identifying (‘fingerprinting’) each contact, and can then merge or synchronize information from contacts which are deemed to be the same contact.

The systems can be programmed to never lose data, wherein merged contacts can be easily separated into their pre-merged form. One method that enables this feature is to use the system to tag every piece of information or data field in the merged contact database or address book with information about its source. Additionally, the system can be programmed to not have any false positives (i.e. never fingerprint or identify two different contacts as the same or a common contact) and assists the user in handling similar contacts (contacts for which the algorithm produced a similar or similar enough, but beyond the user defined threshold fingerprint) which may be common.

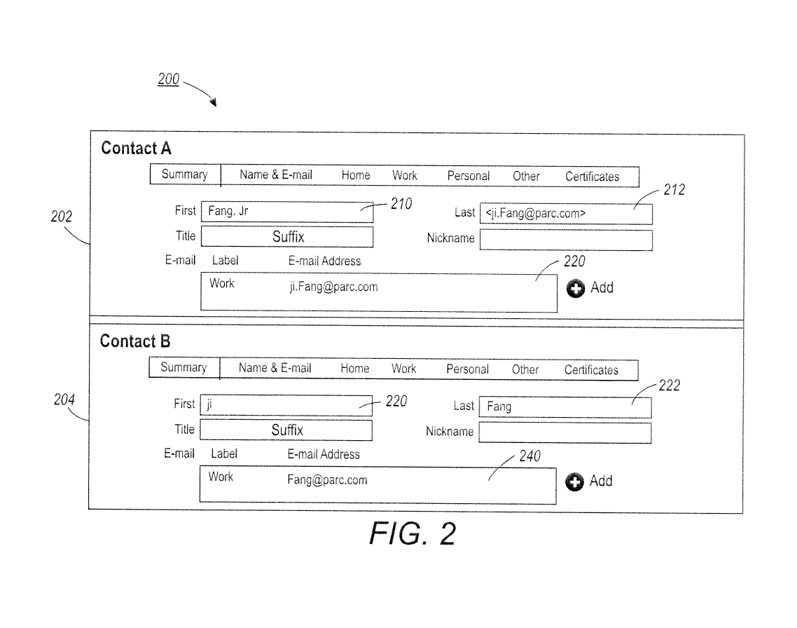

For the purpose of generating the contact fingerprint, the system can implement semantic and syntactic analysis such as named entity recognition to correctly compare names, addresses and other textual fields in the contact. For example, the existent synchronization technologies fail to merge the contacts in FIG. 2, in which both the names and email addresses appear to be different.

The inability to match the two contacts 200, Contact A 202 and B 204, in FIG. 2, is primarily caused by the lack of a named entity recognition step. For example, Contact A 202 incorrectly identified a whole name ‘Fang, Ji’ as a first name 210, and identified an email address included inside brackets ‘< >’ as a last name 212. The present system can correct this mistake by performing named entity recognition techniques on the name fields, and can correctly identify ‘Ji’ as the first name 220 and ‘Fang’ as the last name 222 for Contact A, because ‘Last Name, First Name’ is a common name pattern. In addition, because Firstname.LastName@xyz.com’ 230 is also a common pattern (semantic pattern), the system can safely conclude that the name of Contact A 202 matches the name of Contact B 204, and thus can merge and synchronize the above two contacts into a single common contact.

In some cases, the system might not have sufficient information about the names. For example, if Contact B 204 does not provide correct name information, even though the email address ‘Ji.Fang@parc.com’ 230 and ‘fang@parc.com’ 240 look similar and are likely to belong to the same person, the system will not make the merging decision based on this similarity alone. Instead, the system can mine the email content associated with these addresses and compare the topics and language styles reflected in the email content. If the content associated with the two addresses 230, 240 share the same topics and language styles, the system will merge them. For example, by mining the email content, the system discovers that the above two email addresses 230, 240 share some topics such as ‘natural language processing’, ‘conferences’, and ‘workshops’, and the greeting styles associated with these two email addresses are also very similar. Taking into account this additional evidence, the system concludes that these two email addresses 230, 240 are associated with the same contact and can be merged.

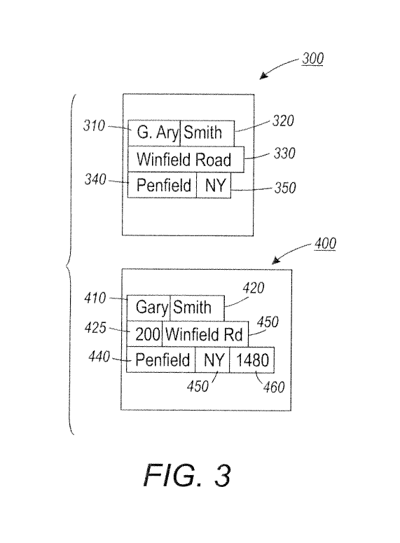

In another example (FIG. 3), the system can use physical address information or phone numbers to correct or match up contacts and contact information. One contact 300, for example, can have the following contact information or address book of data fields: G. Ary 310 Smith 320, Winfield Road 330, Penfield 340, NY 390. Web searches of pieces of the name and/or address may yield nearly matching names in texts or address fields published in other directories. Matching a number of these hits may yield the more likely name/address combination 400, such as another address book of data fields which has the following: Gary 410 Smith 420, 200 425 Winfield Rd 430, Penfield 440, NY 450 1480 460. The system can synchronize and correct the contact information based on the determination that both of the contacts 300, 400 represent a common contact.

The system and method can also take into account the source of the information, e.g. is the source of the information self-provided information on sites such as LinkedIn and Facebook. Information on these self-provided sites is likely to be more accurate or up-to-date than information found from other sources, such as phone directories, where a third person may have entered the information into the database. Comparing dates of entries (i.e. last updated date) will provide another piece of information. These associated pieces of information can be used to validate or grade the information.

In addition, the algorithm employs image categorization, image comparison, and image analysis algorithms to compare contact images. Although not shown, if images accompany the contact information, then the system may discover that the images associated with Contact A and Contact B belong to the same person. Therefore, these two contacts can be merged. The system can use both contact images chosen for email accounts and images associated with email addresses in social networking sites such as Facebook and LinkedIn. For example, a contact image may have been chosen for Contact A when the email account was set up. However, there may be no image associated with Contact B. In this case, the system will try and find an image associated with the email address listed in Contact B in sites such as Facebook. If the system determines that these two images belong to the same person, it can merge these two contacts. It is to be appreciated that the system can use the additional profile information, e.g. another address book or second contact information, to help merge contacts and to correct mistakes in the first address book(s) or first contact information. Without this correction step, some contacts will remain unmerged even if updated profile information is provided to the system. The result produced by the system can comprise a common or master contact list, which is the super-set of its input contact lists (contacts A and B), thus allowing a user one single source of up-to-date and highly accurate contact information.

Profile information fields may include information associated with a profile, such as a profile identification (ID) field, a profile name field, a profile passcode field, etc. For example, the profile ID field may include an identification number (e.g., “001”) for a profile, the profile name field may include a name (e.g., “Richard Smith”) of a user associated with the profile, and the profile passcode field may include an encrypted passcode (or password) associated with accessing the profile.

Identification fields may include identification information about a user associated with the profile, such as a last name field, a first name field, a title field, etc. For example, the last name field may include a last name (e.g., “Smith”) of the user associated with the profile, the first name field may include a first name (e.g., “Richard”) of the user, and the title field may include a title (e.g., “Doctor”) of the user.

Employment information fields may include employment information for a user associated with the profile, such as a work street field, a work city field, a work state field, a work phone field, a professional experiences field, etc. For example, the work street field may include a street name (e.g., “40 Sylvan Road”) for the user's place of employment, the work city field may include a city name (e.g., “Waltham”) for the user's place of employment, the work state field may include a state name (e.g., “Massachusetts”) for the user's place of employment, the work phone field may include a telephone number (e.g., “781-111-1111”) for the user's place of employment, and the professional experiences field may include a description of the user's professional experiences.

Home information fields may include residence information for a user associated with a profile, such as a home street field, a home city field, a home state field, and a home phone field. For example, the home street field may include a street name (e.g., “33 Lexington Street”) for the user's residence, the home city field may include a city name (e.g., “Newton”) for the user's residence, the home state field may include a state name (e.g., “Massachusetts”) for the user's residence, and the home phone field may include a telephone number (e.g., “555-555-5555”) for the user's residence.

Cell phone field may include a telephone number (e.g., “666-666-6666”) for a cellular phone of a user associated with a profile. Email address field may include an email address (e.g., “Richard.Smith@email.com”) of a user associated with a profile.

Personal preferences fields may include personal preference information for a user associated with a profile, such as a favorite movie field, a favorite sport field, a personal pictures field, and a personal videos field. For example, the favorite movie field may include a name (e.g., “Gone With The Wind”) of the user's favorite movie, the favorite sport field may include a name (e.g., “football”) of the user's favorite sport, the personal pictures field may include a list of the user's favorite pictures, and the personal videos field may include a list of the user's favorite videos.

Personal account information field may include account information for a user associated with a profile. For example, personal account information field may include login information, billing information, etc.

The aforementioned techniques can be based on linguistic analysis of contact fields (last name, first name, email address) to correct them according to their type. The described techniques can further use body email analysis to check if two potential email addresses participated in the same discussion. The techniques can validate, or not, the same owner of these emails. Still further, the techniques can be based on web searches over dedicated web sites (white pages, home pages . . . ) and can validate or correct contact details. The techniques can also use social web sites to compare individual photos and check if two contacts are the same. The individual techniques or approaches described above can have limitations that can be compensated by one or more of the other techniques. It is to be appreciated that correcting contact lists can be accomplished according to different sources of information. The correcting of contact lists can be used, for example, to cleanse contact databases for personalized marketing and/or to offer a new service to customers.

A method for augmenting contact information has been described above which comprises storing in a first device a first contact and associated first contact information; and, providing to a server the first contact and the first contact information. The system further comprises storing in at least a second device a second contact and associated second contact information; and, providing to the server the second contact and the second contact information. The server can receive the first contact and the first contact information from the first device, and can receive the second contact and the second contact information from the at least second device. The server can analyze the first contact information and the second contact information to determine whether the first contact and the second contact are a common contact. The server is configured to analyze the first contact information and the second contact information to determine a first likelihood that the second contact and the first contact are the same contact. The server is further configured to analyze the first contact information and the second contact information to determine a second likelihood that the second contact information augments the first contact information of the first contact. If the first and the second likelihoods are higher than pre-set thresholds, the system will augment the first contact information with the second contact information using unique or non-duplicative data fields from the second contact information. The augmenting can result in at least one unique or non-duplicative data field being added or amended to the first contact information. Illustratively, the aforementioned data field augmentation can result in several different outcomes. If the first contact information does not have the identifier “business phone 2” and therefore no corresponding value, while the second contact information has identifier “business phone 2” along with a value; then the first contact information will be updated with the identifier and the value. Alternatively, if the first contact information has the identifier “business phone 2” but not corresponding value, while the second contact information has identifier “business phone 2” and a value; then the first contact information will be updated with the value only. The analyzing can be based on comparisons selected from the group consisting of field mapping, image comparison, named entity comparison, source comparison, search-engine retrieved-data comparison, and content comparison.

The present disclosure also provides for another technique for merging and/or synchronizing multiple sets of data. As an example, one may have stored in a computer or similar many contacts for which there are three phone numbers, home, work and mobile associated with each contact. If an attempt is made to link the contacts between, for example, a laptop, a mobile phone, and a Google web account, in some places the qualification of the phone identifier (whether it's a home, work, or mobile phone number), can be lost. The result is three phone numbers that lack the associated identifier. In some of these occurrences, one can simply start by searching the place of employment of the person in question to determine the appropriate number to identify as the work number. The next step is to look at the remaining two fields of phone numbers and conduct, for example, a search of home addresses. The home address search results along with an associated phone number will identify the home telephone number. Then by process of elimination, the one phone number that is left is the mobile phone number. This analysis represents deduction or association analysis.

The aforementioned system and method provides for a means for placing some value, likelihood, or weight on each of the contacts and associated contact information. The weights or values can be placed on the contact information to demonstrate that one database or data field is more updated or current than another version of the contact information. The aforementioned provides a method for determining the likelihood that one data field is more up-to-date or reliable than another based on any number of parameters, such as, the value of the data field itself, the date associated with the information, the origin of the information, etc. This in turn will facilitate source comparisons or search-engine retrieved-data comparisons for validating and/or grading information to compare data fields and determine which one has the greater likelihood of being accurate. In this manner, data can be correctly updated and synchronized. It is to be appreciated that source comparisons or search-engine retrieved-data comparisons additionally comprise the data and associated weights which can also be used to de-value certain databases that may be suspect regarding the authenticity and/or security of the data and its source. If one does not know the source of data or suspects that the data may be fraudulent, then values can be placed on the data fields that essentially nullify the contact information unless the data can be verified. If the data can be verified, then data fields will be synchronized according to the previously described methods. Thus, the source comparisons or search-engine retrieved-data comparisons also support fraud detection.

Even though particular combinations of features and methods are recited in the claims and/or disclosed in the specification, these combinations are not intended to limit the disclosure. In fact, many of these features and methods may be combined in ways not specifically recited in the claims and/or disclosed in the specification.

1. A system for augmenting contact information, comprising:
a first device configured to store a first contact and first contact information; and provide, to a server, said first contact and said first contact information;
at least a second device configured to store a second contact and second contact information; and provide, to said server, said second contact and said second contact information;
said server configured to receive said first contact and said first contact information from said first device, and receive said second contact and said second contact information from said at least second device;
said server configured to analyze said first contact information and said second contact information to determine a first likelihood that said second contact and said first contact are the same contact;
said server configured to analyze said first contact information and said second contact information to determine a second likelihood that said second contact information augments said first contact information of said first contact;
if said first and said second likelihoods are higher than pre-set thresholds, augment said first contact information with said second contact information using unique data fields from said second contact information; and,
wherein said analyzing comprises at least one comparison selected from the group consisting of natural language processing, named entity recognition, field mapping, content comparison, source comparison, search-engine retrieved-data comparison, and image comparison.

2. The system of claim 1, wherein said augmenting results in at least one said data field being added to said first contact information.

3. The system of claim 1, wherein said augmenting results in a particular value from at least one said unique data field being amended from said first contact information to said second contact information.

4. The system of claim 1, wherein said augmenting results in at least one said data field being purged from said first contact information or said second contact information.

5. The system of claim 1, wherein each of said data fields is tagged in said first contact information and said second contact information with identifiers about their respective origin.

6. The system of claim 1, wherein each of the first and the at least second user devices comprises one or more of: a radiotelephone, a personal communications system (PCS) terminal, a personal digital assistant (PDA), a laptop, a personal computer, a set-top box (STB), a television, a SmartPhone, or a personal gaming system.

7. The system of claim 1, wherein said first contact information and said second contact information include said unique data fields comprising at least one of: contact information associated with said first contact, personal information associated with said first contact, professional information associated with said first contact, personal preferences associated with said first contact, or collections of favorite music, movies, or pictures associated with said first contact.

8. The system of claim 1, wherein said first device and said at least second device are the same device.

9. The system of claim 1, wherein said first contact information and said second contact information are the same contact information.

10. A system for augmenting contact information, comprising:
a first device configured to store a first contact and associated first contact information; and provide, to a server, said first contact and said first contact information;
at least a second device configured to store a second contact and associated second contact information; and provide, to said server, said second contact information;
said server configured to receive said first contact and said first contact information from said first device, and receive said second contact and said second contact information from said at least second device;
said server configured to analyze said first contact information and said second contact information to determine a first likelihood that said second contact and said first contact are the same contact;
said server configured to analyze said first contact information and said second contact information to determine a second likelihood that said second contact information augments said first contact information of said first contact;
if said first and said second likelihoods are higher than pre-set thresholds, augment said first contact information with said second contact information using unique data fields from said second contact information;
each of the data fields is tagged in said first contact information and said second contact information with identifiers about respective origin;
wherein said augmenting results in at least one said unique data field being added or amended to said first contact information; and,
wherein said analyzing comprises at least one comparison selected from the group consisting of natural language processing, named entity recognition, field mapping, content comparison, source comparison, search-engine retrieved-data comparison, and image comparison.

11. The system of claim 10, wherein each of the first and the at least second user devices comprises one or more of: a radiotelephone, a SmartPhone, a personal communications system (PCS) terminal, a personal digital assistant (PDA), a laptop, a personal computer, a set-top box (STB), a television, or a personal gaming system.

12. The system of claim 10, wherein said first contact information and said second contact information include said unique data fields comprising at least one of: contact infoitnation associated said first contact, personal information associated with said first contact, professional information associated with said first contact, personal preferences associated with said first contact, or collections of favorite music, movies, or pictures associated with said first contact.

13. The system of claim 10, wherein said first device and said at least second device are the same device.

14. The system of claim 10, wherein said first contact information and said second contact information are the same contact information.

15. A method for augmenting contact information, comprising:
storing in a first device a first contact and associated first contact information;
providing to a server said first contact and said first contact information;
storing in at least a second device a second contact and associated second contact information;
providing to said server said second contact and said second contact information;
said server receiving said first contact and said first contact information from said first device, and receiving said second contact said second contact information from said at least second device;
said server analyzing said first contact information and said second contact information to determine whether said first contact and said second contact are a common contact;
said server configured to analyze said first contact information and said second contact information to determine a first likelihood that said second contact and said first contact are the same contact;
said server configured to analyze said first contact information and said second contact information to determine a second likelihood that said second contact information augments said first contact information of said first contact; and,
wherein said analyzing is further based on comparisons selected from the group consisting of field mapping, image comparison, named entity comparison, source comparison, search-engine retrieved-data comparison, and content comparison.

16. The method of claim 15, wherein if said first and said second likelihoods are higher than pre-set thresholds, augment said first contact information with said second contact information using unique data fields from said second contact information; and,
wherein said augmenting results in at least one said unique data field being added or amended to said first contact information.

17. The method of claim 16, wherein each of the data fields is tagged in said first contact information and said second contact information with identifiers about origin.

18. The method of claim 17, wherein each of the first and the at least second user devices comprises one or more of: a radiotelephone, a SmartPhone, a personal communications system (PCS) terminal, a personal digital assistant (PDA), a laptop, a personal computer, a set-top box (STB), a television, or a personal gaming system.

19. The method of claim 18, wherein said first contact information and said second contact information include said unique data fields comprising at least one of: contact information associated said first contact, personal information associated with said first contact, professional information associated with said first contact, personal preferences associated with said first contact, or collections of favorite music, movies, or pictures associated with said first contact.

20. The method of claim 19, wherein said first device and said at least second device are the same device.
